(19) United States
(12) Patent Application Publication
(10) Pub. No.: US 2008/0094998 A1
(43) Pub. Date: Apr. 24, 2008

(54) SYSTEM FOR GENERATING REFERENCE BEAM ANGLE CONTROL SIGNAL AND HOLOGRAPHIC INFORMATION RECORDING AND/OR REPRODUCING APPARATUS EMPLOYING THE SYSTEM

(75) Inventors: Taek-seong JEONG, Suwon-si (KR); Jong Chul Choi, Suwon-si (KR); Moon-Il Jung, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/781,490

(22) Filed: Jul. 23, 2007

(30) Foreign Application Priority Data
Oct. 24, 2006 (KR) 2006-103610

(51) Int. Cl. G11B 7/00

(52) U.S. Cl. 369/103

(57) ABSTRACT

A system for generating a reference beam angle control signal and a holographic information recording and/or reproducing apparatus including the system are provided. When record of a two-dimensionally (2D) modulated signal beam superposed in the same volume of a holographic medium is called a book, the system includes: a first photo-detector and a second photo-detector arranged to detect signal beams reproduced from first and second adjacent books disposed on both sides of a specific book that is to be reproduced from the holographic medium; and a signal processing unit arranged to obtain a reference beam angle control signal for controlling the incident angle of a reference beam emitted to the holographic medium using a differential signal between output signals of the first and second photo-detectors.

### CROSS-REFERENCE TO RELATED APPLICATIONS

This application claims all benefits accruing under 35 U.S.C. §119 from Korean Patent Application No. 2006-103610, filed on Oct. 24, 2006, in the Korean Intellectual Property Office, the disclosure of which is incorporated herein by reference.

### BACKGROUND OF THE INVENTION

1. Field of the Invention

The present invention relates to a system for generating a reference beam angle control signal and a holographic information recording and/or reproducing apparatus employing the system, and more particularly, to a system that can simply generate a control signal for controlling a reference beam to be emitted at an optimum angle during reproduction, and a holographic information recording and/or reproducing apparatus employing the system.

2. Related Art

Holographic storage typically achieves high data density by overlapping and recording many holograms in the same volume of a holographic medium. In holographic storage, recording is performed through interference between a signal beam and a reference beam. The signal beam is modulated by a spatial light modulator (SLM) into the form of pages including a plurality of pixel data.

During a recording mode, the signal beam in the form of pages passes through an optical system and interferes with a reference beam on the holographic medium to form an interference pattern. The interference pattern is recorded on the holographic medium. During a reproduction mode, a reference beam is incident on the recorded interference pattern, and the original signal beam recorded on the holographic medium is reproduced due to diffraction. If the reference beam used for reproducing is different from the reference beam used for recording, the intensity and direction of the reproduced beam become different from those of the original beam recorded on the holographic medium. When the difference is large, the light intensity reduces in the form of a sinc function. In particular, when the interference pattern is recorded using plane waves, there is a position where the light intensity becomes zero (0). This position is referred to as a first null Bragg selectivity. However, since the page data-laden signal beam is generally made up of a combination of plane waves, the light intensity nears zero (0) in a second null Bragg selectivity position, not in the first null Bragg selectivity position, which is more obvious as the volume of the page data increases.

Accordingly, by recording another hologram in a position where the intensity of diffraction light of a previous recorded signal beam nears zero (0), a plurality of pages can be recorded without interference between the pages. Holographic storage based on this phenomena can record to be superposed a plurality of pages in the same volume of the holographic medium. For example, angular multiplexing recording method can record a plurality of pages in the same location by focusing the signal beam on the same position and changing only the angle of the reference beam by an integer multiple of null Bragg selectivity. A record of the plurality of pages superposed on the same location of the holographic medium may be called a book. The recording density can be increased by recording as many books as close as possible.

However, in angular multiplexing recording, regions where the signal beam and the reference beam intersect with each other should be separated a predetermined distance from each other. Since the regions where the signal beam and the reference beam intersect partially overlap with each other in general angular multiplexing, a plurality of signal beams may be reproduced from different books with respect to a single reference beam, thereby failing to read out a desired signal beam. To improve this problem, an aperture can be disposed in the path of the signal beam to cut off other signal beams than the desired signal beam.

However, during the reproduction process of the holographic storage, the angle of the reference beam needed for reproducing the signal beam can be varied according to temperature change or shrinkage due to the reaction of the holographic medium, resulting in degradation of the reproduced signal beam.

Accordingly, it is necessary to optimize a reproduced image by adjusting the angle of the reference beam. The angle of the reference beam can be selected as an optimum angle when the quality of the reproduced signal beam is the best. However, a two-dimensional (2D) detector array, such as a charge coupled device (CCD) or a complementary metal-oxide semiconductor (CMOS), generally used as a signal beam sensor does not transfer data at high speed, thereby taking much time to analyze data for the purpose of obtaining the optimum angle.

To complement this problem, a method of aligning the angle of a reference beam using a system that collects part of a reproduced signal beam using a lens and measures the collected signal beam using a photo-detector (PD) has been proposed by Seong-Hun Lee, et al., in a paper entitled “The Angle Align Method of Reference Beam for Holographic Data Storage” which appears in Optical Data Storage (ODS), 2006.

According to the angle align method disclosed by Seong-Hun Lee, the intensity of a total image can be obtained by collecting part of the reproduced signal beam using the lens and measuring the collected signal beam using the photo-detector (PD). Since the angle of the reference beam is the optimum angle for reproducing when the intensity of the image is highest, a reproduction process is performed when the value measured by the photo-detector (PD) is highest.

Since the photo-detector (PD) operates at very high speed, the optimum angle of the reference beam can be obtained quickly. However, using the conventional method disclosed by Seong-Hun Lee, part of the signal beam is lost. In general, since the intensity of the signal beam increases with the increase of the consumption of the holographic medium, the loss of the signal beam affects the recording capacity. In addition, the conventional method requires additional components such as the lens or a beam splitter, thereby increasing the size of the system. Furthermore, it is very time consuming to obtain the optimum angle by tracking the maximum measurement value because there is no information about the direction of an optimum change in the angle.

### SUMMARY OF THE INVENTION

Several aspects and example embodiments of the present invention provide a system for generating a reference beam angle control signal, to obtain the optimum angle of a reference beam without loss of a signal beam when holograms recorded on a holographic medium are reproduced, and a holographic information recording and/or reproducing apparatus employing the system.

Additional aspects and/or advantages of the invention will be set forth in part in the description which follows and, in part, will be obvious from the description, or may be learned by practice of the invention.

In accordance with an aspect of the present invention, there is provided a system for generating a reference beam angle control signal, the system comprising: when record of two-dimensionally (2D) modulated signal beam superposed in the same volume of a holographic medium is called a book, a first photo-detector and a second photo-detector detecting signal beams reproduced from first and second adjacent books respectively disposed on both sides of a specific book that is to be reproduced from the holographic medium; and a signal processing unit obtaining a reference beam angle control signal for controlling the incident angle of a reference beam emitted to the holographic medium using a differential signal between output signals of the first and second photo-detectors.

According to an aspect of the present invention, the system may further comprise an aperture member disposed in the optical path of a signal beam reproduced when the emitted reference beam is diffracted by the holographic medium, and having an aperture through which only a signal beam reproduced from the specific book can pass, wherein the first and second photo-detectors are integrally formed with the aperture member to be disposed on both sides of the aperture, respectively.

According to an aspect of the present invention, the system may further comprise: an aperture member disposed in the optical path of a signal beam reproduced when the emitted reference beam is diffracted by the holographic medium, and having an aperture through which only a signal beam reproduced from the specific book can pass; and first and second mirrors integrally formed with the aperture member to be disposed on both sides of the aperture, respectively, and reflecting signal beams reproduced from the first and second adjacent books, wherein the first photo-detector detects a signal beam reflected by the first mirror, and the second photo-detector detects a signal beam reflected by the second mirror.

According to an aspect of the present invention, the first and second photo-detectors may be disposed to directly detect signal beams reproduced from the first and second adjacent books.

According to an aspect of the present invention, the system may further comprise first and second mirrors reflecting signal beams reproduced from the first and second adjacent books, wherein the first photo-detector detects a signal beam reflected by the first mirror, and the second photo-detector detects a signal beam reflected by the second mirror.

According to an aspect of the present invention, the specific book, the first adjacent book, and the second adjacent book may be recorded at different angles on the holographic medium.

According to an aspect of the present invention, an angular spacing between adjacent pages within the same book may correspond to an integer multiple of null Bragg selectivity, when a hologram is recorded by a signal beam modulated in a 2D manner in the form of page, and the book refers to a record of the plurality of pages superposed in the same volume of the holographic medium, and an angular spacing between adjacent books may correspond to a ratio of null Bragg selectivity to n where n is greater than 1.

In accordance with another aspect of the present invention, there is provided a holographic information recording and/or reproducing apparatus comprising: a first reference beam emitting unit to adjust an incident angle of a reference beam and emit an adjusted reference beam to a holographic medium; a signal beam sensor arranged to, when record of a 2D modulated signal beam superposed in the same volume of the holographic medium is called a book, detect a signal beam reproduced from a specific book that is to be reproduced from the holographic medium using the reference beam emitted by the first reference beam emitting unit; and a system for generating a reference beam angle control signal to control the incident angle of the reference beam emitted by the first reference beam emitting unit to the holographic medium, wherein the system for generating the reference beam angle control signal comprises: first and second photo-detectors to detect signal beams reproduced from first and second adjacent books disposed on both sides of the specific book, respectively; and a signal processing unit to obtain a reference beam angle control signal for controlling the incident angle of the reference beam emitted by the first reference beam emitting unit to the holographic medium using a differential signal between output signals of the first and second photo-detectors.

According to an aspect of the present invention, the holographic information recording and/or reproducing apparatus may further comprise: a light source to emit light; a first beam splitter to split the light emitted by the light source into two beams; and a signal beam provider to modulate a first beam of the two beams splitted by the first beam splitter into a signal beam having a 2D signal pattern and emit the signal beam having the 2D signal pattern to the holographic pattern, wherein a second beam of the two beams splitted by the first beam splitter is used as a reference beam.

According to an aspect of the present invention, the holographic information recording and/or reproducing apparatus may further comprise: a second beam splitter to split the second beam of the two beams splitted by the first beam splitter into first and second reference beams; and a second reference beam emitting unit to adjust the incident angle of the first reference beam to use for recording and emit an adjusted first reference beam to the holographic medium, wherein the second reference beam is used as the reference beam emitted to the holographic medium by the first reference beam emitting unit.

According to an aspect of the present invention, the first reference beam emitting unit may comprise a pivoting mirror to reflect a reference beam incident thereon, such that the pivoting mirror is driven according to the reference beam angle control signal to adjust the angle of the reference beam.

According to an aspect of the present invention, the holographic information recording and/or reproducing apparatus may further comprise a lens system for transmitting the signal beams reproduced from the specific book and the first and second adjacent books.

According to an aspect of the present invention, the lens system may comprise: a first lens to convert the signal beam reproduced from the holographic medium into a parallel beam; a second lens to focus the parallel beam output from the first lens on a plane including the aperture; and a third lens to convert the signal beam focused by the second lens, and then diversed, passing through the aperture to be reproduced from the specific book into a parallel beam and to transmit the parallel beam to the signal beam sensor.

According to an aspect of the present invention, the signal beam emitted by the signal beam provider to the holographic medium and the signal beam reproduced from the specific book on the holographic medium may travel in the same path.

In accordance with another example embodiment of the present invention, a holographic information recording and/or reproducing apparatus for recording and/or reproducing information on/from a holographic medium is provided in which a hologram is recorded in the form of a page and a record of a plurality of pages superposed in the same volume of the holographic medium is referred to as a book. Such an apparatus comprises a reference beam emitter to emit a reference beam to the holographic medium; a signal beam sensor arranged to detect a signal beam reproduced from a specific book that is to be reproduced from the holographic medium using the reference beam emitted by the reference beam emitter; an aperture member disposed in an optical path of the signal beam reproduced when the reference beam is diffracted by the holographic medium, and having an aperture through which only the signal beam reproduced from the specific book can pass, first and second photo-detectors disposed on both sides of the aperture to detect signal beams reproduced from first and second adjacent books disposed on both sides of a specific book, respectively; and a signal processor to generate a reference beam angle control signal for controlling an incident angle of the reference beam emitted by the reference beam emitter to the holographic medium using a differential signal between output signals of the first and second photo-detectors.

According to an aspect of the present invention, the holographic information recording and/or reproducing apparatus is further provided with a light source to emit light; a first beam splitter to split the light emitted by the light source into two beams; and a signal beam provider to modulate a first beam of the two beams splitted by the first beam splitter into a signal beam having a 2D signal pattern and to emit the signal beam having the 2D signal pattern to the holographic pattern, wherein a second beam of the two beams splitted by the first beam splitter is used as a reference beam.

According to another aspect of the present invention, the holographic information recording and/or reproducing apparatus is further provided with a second beam splitter to split the second beam of the two beams split by the first beam splitter into first and second reference beams; and a second reference beam emitter to adjust the incident angle of the first reference beam to use for recording and to emit an adjusted reference beam to the holographic medium, wherein the second reference beam is used as the reference beam emitted to the holographic medium by the reference beam emitter.

According to another aspect of the present invention, the reference beam emitter is further provided with a pivoting mirror to reflect a reference beam incident thereon, such that during a reproduction process, the pivoting mirror is driven according to the reference beam angle control signal to adjust the angle of the reference beam.

According to another aspect of the present invention, the holographic information recording and/or reproducing apparatus is further provided with first and second mirrors integrally formed with the aperture member to be disposed on both sides of the aperture respectively, for reflecting the signal beams reproduced from the first and second adjacent books, wherein the first photo-detector detects a signal beam reflected by the first mirror, and the second photo-detector detects a signal beam reflected by the second mirror.

According to another aspect of the present invention, the holographic information recording and/or reproducing apparatus is further provided with a first lens arranged to convert the signal beam reproduced from the holographic medium into a parallel beam; a second lens arranged to focus the parallel beam output from the first lens on a plane including the aperture; and a third lens arranged to convert the signal beam focused by the second lens, and then diversed, pass through the aperture to be reproduced from the specific book into a parallel beam and transmit the parallel beam to the signal beam sensor.

According to an aspect of the present invention, the specific book, the first adjacent book, and the second adjacent book are recorded at different angles on the holographic medium, an angular spacing between adjacent pages within the same book corresponds to an integer multiple of null Bragg selectivity, and an angular spacing between adjacent books corresponds to a ratio of null Bragg selectivity to n where n is greater than 1.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a plan view illustrating major elements of a holographic information recording and/or reproducing apparatus including a reference beam angle control signal generating system according to an example embodiment of the present invention in view of reproducing holographic information;

FIG. 2 is an enlarged perspective view illustrating an aperture member and first and second photo-detectors integrally formed with the aperture member of the holographic information recording and/or reproducing apparatus of FIG. 1, according to an example embodiment of the present invention;

FIG. 3 illustrates that a plurality of books, in each of which a plurality of pages are superposed, overlap with one another on a holographic medium by angular multiplexing;

FIG. 4 is a graph illustrating diffraction efficiency for each of the books of FIG. 3 according to the incident angle of a reference beam;

FIG. 5 is a graph illustrating a reference beam angle control signal obtained by the reference beam angle control signal generating system of FIG. 1;

FIG. 6 is a plan view illustrating major elements of a holographic information recording and/or reproducing apparatus including a reference beam angle control signal generating system according to another example embodiment of the present invention in view of reproducing holographic information; and

FIG. 7 is a plan view of an entire holographic information recording and/or reproducing apparatus including the reference beam angle control signal generating system according to the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. A holographic information recording and/or reproducing apparatus according to an example embodiment of the present invention includes a holographic storage system, such as a hard disk drive (HDD), in which a holographic medium is built, or includes a drive system or a player system, such as an optical disk drive or an optical disk player, to or from which a holographic medium is attached or detached.

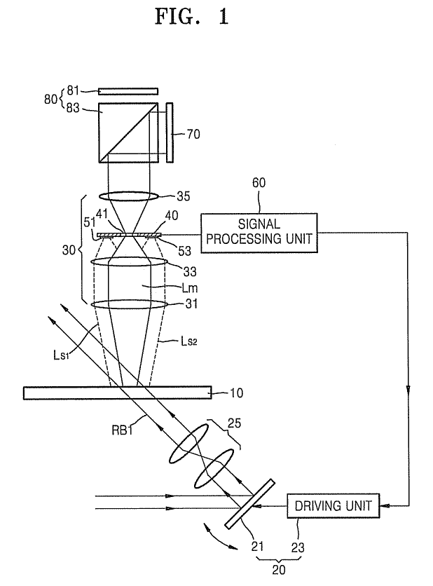

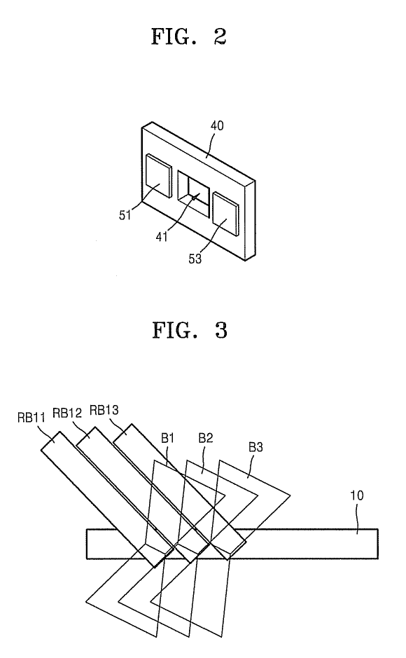

FIG. 1 is a plan view illustrating major elements of a holographic information recording and/or reproducing apparatus including a reference beam angle control signal generating system according to an example embodiment of the present invention in view of reproducing holographic information. FIG. 2 is a perspective view illustrating an aperture member and first and second photo-detectors integrally formed with the aperture member of the holographic information recording and/or reproducing apparatus of FIG. 1, according to an example embodiment of the present invention.

Referring to FIGS. 1 and 2, the reference beam angle control signal generating system includes first and second photo-detectors 51 and 53 for respectively detecting signal beams Lₛ₁ and Lₛ₂ reproduced from first and second adjacent books disposed on both sides of a specific book that is to be reproduced from a holographic medium 10, and a signal processing unit 60 for obtaining a reference beam angle control signal using a differential signal between output signals of the first and second photo-detectors 51 and 53.

When a hologram is recorded by a signal beam modulated in a two-dimensional (2D) manner in the form of page, a book refers to a record of the plurality of pages superposed in the same volume of the holographic medium 10. According to example embodiments of the present invention, the terms “book” and “page” are not absolute, and can be changed into other appropriate terms.

Here, the adjacent books may be recorded at different angles. That is, holographic information may be recorded on the holographic medium 10 by ensuring a constant angular difference between the specific book and the first adjacent book, and between the specific book and the second adjacent book. Accordingly, the specific book, the first adjacent book, and the second adjacent book are recorded at different angles. Preferably, holographic information may be recorded on the holographic medium 10 so that an angular spacing between adjacent pages within the same book corresponds to an integer multiple of null Bragg selectivity, where the integer is greater than one (1), and an angular spacing between adjacent books corresponds to a ratio of null Bragg selectivity to n, where n is greater than one (1).

FIG. 3 illustrates that a plurality of books B1, B2, and B3, in each of which a plurality of pages are superposed, overlap with one another on a holographic medium 10 by angular multiplexing. Referring to FIG. 3, for example, when a plurality of pages are recorded in the same book by changing the angle of a reference beam by two times null Bragg selectivity, a plurality of books can be recorded in such a manner that an angular spacing between adjacent books corresponds to half (½) null Bragg selectivity.

When the books B1, B2, and B3 are recorded as illustrated in FIG. 3 and the angle of a reference beam RB12 emitted to record the book B2 is θ, a reference beam RB11 is emitted at an angle obtained by subtracting half (½) of null Bragg selectivity from the angle θ (θ−selectivity/2) to record the book B1 and a reference beam RB13 is emitted at an angle obtained by adding the angle θ to half of null Bragg selectivity (θ+selectivity/2) to record the book B3. In FIG. 3, when the book B2 is the specific book, the books B1 and B3 are the first and second adjacent books, respectively.

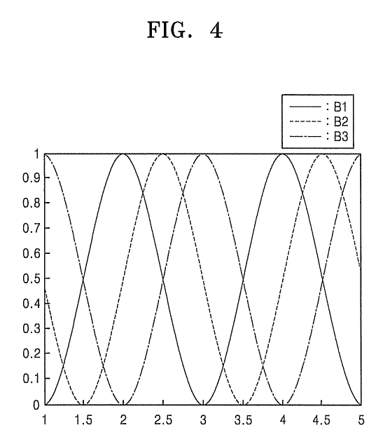

When adjacent books are recorded at different angles on the holographic medium 10 in this manner, intensity efficiency for each book is obtained according to the angle of a reference beam during reproduction as shown in FIG. 4. Referring to FIG. 4, a graph illustrating diffraction efficiency for each of the books B1, B2, and B3 according to the incident angle of a reference beam is shown. The X-axis as shown in FIG. 4 is represented in units of null Bragg selectivity. When the specific book B2 is reproduced, the signal beams Lₛ₁ and Lₛ₂ reproduced from the first adjacent book B1 and the second adjacent book B3 are collected by the lens system 30 on the first and second photo-detectors 51 and 53.

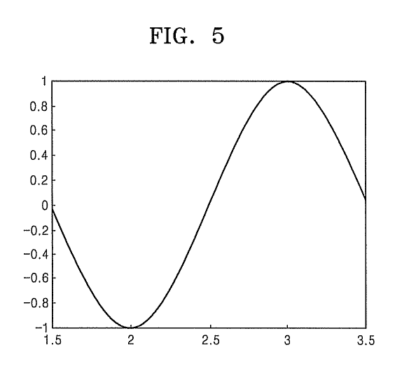

A reference beam angle control signal, as shown in FIG. 5, is obtained at the signal processing unit 60 by subtracting an output signal of the first photo-detector 51 for the first adjacent book B1 from an output signal of the second photo-detector 53 for the second adjacent book B3.

Referring to FIG. 5, the efficiency of the specific book B2 is highest at an angle of 2.5 (in units of selectivity) where the reference beam angle control signal is zero (0). As the angle increases above the angle of 2.5, the reference beam angle control signal increases, and as the angle decreases below the angle of 2.5, the reference beam angle control signal decreases. In particular, the reference beam angle control signal curve shown in FIG. 5 is linear in a central region. According to the movement direction of the angle, the error of the angle is produced as the reference beam angle control signal. Accordingly, the angle of the reference beam can be controlled using the reference beam angle control signal. That is, the reference beam angle control signal is controlled to be zero (0) by decreasing the angle when the reference beam angle control signal is greater than zero (0), and increasing the angle when the reference beam angle control signal is less than zero (0).

As a pivoting mirror 21 of a first reference beam emitting unit 20 to adjust the incident angle of the reference beam and to emit the adjusted reference beam to the holographic medium 10, a galvano mirror may be generally used. Since the galvano mirror is moved in proportion to a voltage applied thereto, the galvano mirror can control the angle of the reference beam to achieve the maximum efficiency by adding or subtracting the reference beam angle control signal to or from a driving voltage. For the reproduction of next page, when voltage which can jump one period of the reference angle control signal is added or subtracted to a driving voltage, the angle of the reference beam can be controlled to be suitable for the next page. The angle of the reference beam can be adjusted to skip over several pages as the magnitude of added or subtracted signal.

For example, when an initial driving voltage of the galvano mirror (i.e., pivoting mirror 21) is applied to correspond to an angle of 2, the efficiency of the specific book B2 to be reproduced is zero (0) as shown in FIG. 4, and the reference beam angle control signal is negative value (−1) as known in FIG. 5.

When the scale of the reference beam angle control signal is adjusted and then subtracted from the driving voltage, the driving voltage increases and the angle of the galvano mirror (i.e., pivoting mirror 21) increases. As a result, when reproduction efficiency increases to be close to the maximum value, the reference beam angle control signal nears zero (0) and stable control can be achieved at an angle of 2.5° which is the maximum efficiency angle. On the contrary, when an initial driving voltage is applied to correspond to an angle of 3, stable control can be achieved at the angle of 2.5 by driving the galvano mirror (i.e., pivoting mirror 21) in the opposite direction.

While it is described that the plurality of pages are recorded in the same book by changing the angle of the reference beam by two times null Bragg selectivity, the present embodiment is not limited thereto, and the pages may be recorded at a different angle interval and the reference beam angle control signal may be generated on the same concept.

The holographic information recording and/or reproducing apparatus of FIG. 1 includes the first reference beam emitting unit 20 adjusting the incident angle of a reference beam RB1, i.e., a reference beam for reproducing and emitting the adjusted reference beam RB1 to the holographic medium 10, a signal beam sensor 70 detecting a signal beam reproduced as a hologram of a desired position from the holographic medium 10, and the reference beam angle control signal generating system. The holographic information recording and/or reproducing apparatus may further include a signal beam provider 80 that provides a signal beam used to record holographic information to the holographic medium 10. When the signal beam sensor 70 is employed and the signal beam provider 80 is not employed, the holographic information recording and/or reproducing apparatus according to the present embodiment becomes a holographic information reproducing apparatus. When both the signal beam sensor 70 and the signal beam provider 80 are employed, the holographic information recording and/or reproducing apparatus according to the present embodiment becomes a holographic information recording and reproducing apparatus. An operation of the holographic information recording and reproducing apparatus will now be explained.

The first reference beam emitting unit 20 includes the pivoting mirror 21 that adjusts the incident angle of the reference beam RB1 used to reproduce a hologram recorded on the holographic medium 10 and reflects the adjusted reference beam RB1 so that the adjusted reference beam is projected to the holographic medium 10. The pivoting mirror 21 can adjust the angle of the reference beam RB1 by being driven by a driving unit 23 according to the reference beam angle control signal produced by the reference beam angle control signal generating system. The driving unit 23 drives the pivoting mirror 21 according to the reference beam angle control signal input thereto so that the reference beam RB1 is reflected in an appropriate direction. Also, in order to sequentially reproduce holographic information of a plurality of pages recorded at intervals corresponding to integer multiples of null Bragg selectivity from the specific book B2, the driving unit 23 drives the pivoting mirror 21 to emit the reference beam RB1 to the specific book B2 of the holographic medium 10 at intervals corresponding to integer multiples of the null Bragg selectivity.

The reference beam RB1 whose angle is adjusted by being reflected by the pivoting mirror 21 is transmitted to the holographic medium 10 by a relay lens system 25. The relay lens system 25 may be omitted.

The reference beam RB1 emitted to the holographic medium 10 is diffracted by the holographic medium 10 to obtain a signal beam Lm reproduced from the specific book B2. The reproduced signal beam Lm is detected by the signal beam sensor 70. The signal beam sensor 70 may be a charge coupled device (CCD) or a complementary metal oxide semiconductor (CMOS) to detect the reproduced signal beam Lm having a 2D signal pattern.

The signal beam Lm detected by the signal beam sensor 70 is reproduced from the specific book B2 recorded on the holographic medium 10 when the reference beam RB1 is diffracted by the holographic medium 10.

As described above, since the signal beams Lₛ₁ and Lₛ₂ are reproduced from the first and second adjacent books B1 and B3 as well as the signal beam Lm from the specific book B2, the holographic information recording and/or reproducing apparatus according to the present embodiment may further include an aperture member 40 disposed in the optical path of the signal beam Lm reproduced when the reference beam RB1 emitted by the first reference beam emitting unit 20 is diffracted by the holographic medium 10, and having an aperture 41 through which only the signal beam Lm reproduced from the specific book B2 can pass. Here, the aperture member 40 may be regarded as an element of the reference beam angle control signal generating system.

The first and second photo-detectors 51 and 53 may be disposed to directly detect the signal beams Lₛ₁ and Lₛ₂ reproduced from the first and second adjacent books B1 and B3. As shown in FIGS. 1 and 2, the first and second photo-detectors 51 and 53 may be integrally formed with the aperture member 40 to be disposed on both sides of the aperture 41.

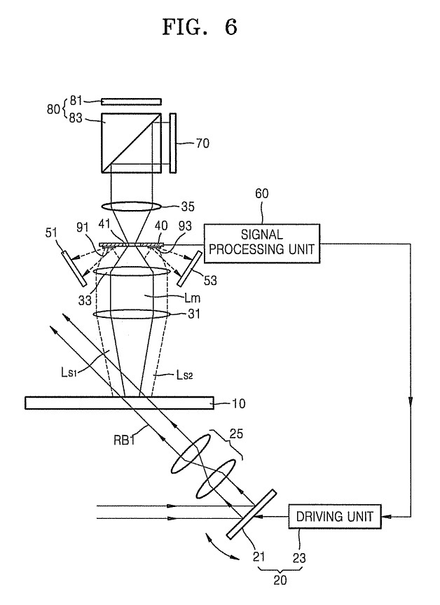

FIG. 6 is a plan view illustrating major elements of a holographic information recording and/or reproducing apparatus including a reference beam angle control signal generating system for reproducing holographic information according to another embodiment of the present invention. Unlike in FIG. 1 and FIG. 2, the reference beam angle control signal generating system of FIG. 6 includes first and second mirrors 91 and 93 integrally formed with an aperture member 40 to be disposed on both sides of an aperture 41 and reflecting signal beams Lₛ₁ and Lₛ₂ reproduced from first and second adjacent books, a first photo-detector 51 disposed to detect the signal beam Lₛ₁ reflected by the first mirror 91, and a second photo-detector 53 disposed to detect the signal beam Lₛ₂ reflected by the second mirror 93.

As shown in FIG. 1 and FIG. 6, a signal beam provider 80, which forms a signal beam used to record holographic information, includes a signal beam modulator 81, e.g., a spatial light modulator (SLM), modulating a light beam incident during a recording mode into a signal beam having a 2D signal pattern in the form of pages and reflecting the signal beam to the holographic medium 10, and an optical path changer 83 changing the optical path of incident light to direct a light beam emitted from a light source (not shown) to the signal beam modulator 81 and direct the signal beam for recording holographic information reflected by the signal beam modulator 81 to the holographic medium 10.

Referring to FIG. 1 and FIG. 6, the holographic information recording and/or reproducing apparatus may be configured such that the signal beam emitted to the holographic medium 10 from the signal beam provider 80 and the signal beam Lm reproduced from the holographic medium 10 travel on the same path.

To this end, the optical path changer 83 reflects the signal beam Lm reproduced from the holographic medium 10 to the signal beam sensor 70, and reflects the light beam incident from the light source (not shown) to the signal beam modulator 81 of the signal beam provider 80. Also, the optical path changer 83 transmits the signal beam having the 2D signal pattern in the form of pages reflected by the signal beam modulator 81 to the holographic medium 10. The signal beam sensor 70 and the signal beam modulator 81 may be disposed according to the function of the optical path changer 83.

Alternatively, the optical path changer 83 may be configured in such a manner that the signal beam sensor 70 and the signal beam modulator 81, as shown in FIG. 1 and FIG. 6, change places with each other.

Referring to FIGS. 1 and 6, the holographic information recording and/or reproducing apparatus may further include a lens system 30 that transmits the signal beams Lm, Lₛ₁, and Lₛ₂ reproduced from the specific book B2 and the first and second adjacent books B1 and B3. The lens system 30 includes a first lens 31 for converting the signal beam Lm reproduced from the holographic medium 10 into a parallel light beam, and a second lens 33 for focusing the parallel light beam generated by the first lens 31 on a plane where the aperture 41 is disposed. The lens system 30 may further include a third lens 35 that constitutes a relay lens system together with the second lens 33, and is adapted to convert the signal beam Lm focused by the second lens 33, expanded, and passing through the aperture 41 to be reproduced from the specific book into a parallel light beam and transmit the parallel light beam to the signal beam sensor 70.

Since the lens system 30 can focus the signal beam Lm reproduced from the holographic medium 10 on the plane where the aperture 41 of the aperture member 40 is formed, the signal beams Lₛ₁ an Lₛ₂ reproduced from the first and second adjacent books are condensed on the first and second photo-detectors 51 and 53, and only the signal beam Lm reproduced from the specific book passes through the aperture 41 and propagates toward the third lens 35.

Unlike the holographic information recording and/or reproducing apparatus of FIG. 1, the first and second photo-detectors 51 and 53 in the holographic information recording and/or reproducing apparatus of FIG. 6 may be separated from the aperture member 40. Alternatively, the aperture member 40 may be omitted from the holographic information recording and/or reproducing apparatus of FIG. 1. This is because the first and second photo-detectors 51 and 53 are disposed in the optical paths of the signal beams Lₛ₁ and Lₛ₂ reproduced from the first and second adjacent books to prevent the signal beams Lₛ₁ and Lₛ₂ from propagating toward the signal beam sensor 70.

In addition, unlike the holographic information recording and/or reproducing apparatus of FIG. 1, the first and second mirrors 91 and 93 may be separated from the aperture member 40. Alternatively, the aperture member 40 may be omitted from the holographic information recording and/or reproducing apparatus of FIG. 6. This is because the first and second mirrors 91 and 93 are disposed in the optical paths of the signal beams Lₛ₁ and Lₛ₂ reproduced from the first and second adjacent books to prevent the signal beams L₁ and Lₛ₂ from propagating toward the signal beam sensor 70.

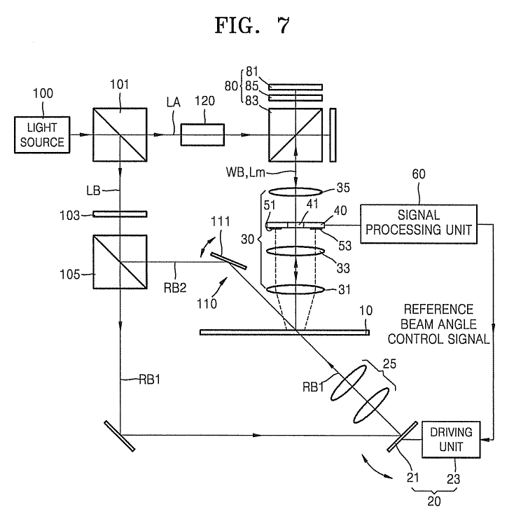

FIG. 7 is a plan view of an entire holographic information recording and/or reproducing apparatus including the reference beam angle control signal generating system of FIG. 1, according to an example embodiment of the present invention. However, the entire holographic information recording and/or reproducing apparatus, as shown in FIG. 7, may include the reference beam angle control signal generating system, as shown in FIG. 6 instead of the reference beam angle control signal generating system, as shown in FIG. 1. This may be easily analogized and thus illustration thereof will not be given. In addition to the original (first) reference beam emitting unit 20, as shown in FIG. 1 and FIG. 6, a second reference beam emitting unit 110 is further provided.

Referring to FIG. 7, the holographic information recording and/or reproducing apparatus includes a light source 100 for generating and emitting a light beam, and a first beam splitter 101 for splitting the light beam emitted by the light source 100 into two light beams.

Among the two light beams, a first light beam LA is transmitted through the first beam splitter 101, is modulated during a recording mode into a signal beam WB having a 2D signal pattern used to record holographic information by the signal beam provider 80 and is emitted to the holographic medium 10. A second light beam LB reflected by the first beam splitter 101 is used as reference beams RB1 and RB2.

The second light beam LB is split by a second beam splitter 105 into a reference beam RB2 for recording information and a reference beam RB1 for reproducing information. During the recording mode, the angle of the reference beam RB2 is adjusted by a pivoting mirror 111 of a second reference beam emitting unit 110 and the adjusted reference beam RB2 is emitted to the holographic medium 10. During a reproduction mode, the angle of the reference beam RB1 is adjusted by the pivoting mirror 21 of the original (first) reference beam emitting unit 20 and the adjusted reference beam RB1 is emitted to the holographic medium 10.

A beam expander 120 may be further disposed in the optical path of the first light beam LA between the first beam splitter 101 and the optical path changer 83 to expand the first light beam LA to a size corresponding to the signal beam modulator 81. A beam expander (not shown) may be further disposed in the optical path of the second light beam LB between the first beam splitter 101 and the second beam splitter 105.

The first beam splitter 101 may be a general beam splitter that can split incident light into the first and second light beams LA and LB at an appropriate ratio.

In the holographic information recording and/or reproducing apparatus according to the present embodiment, the signal beam provider 80 may further include a quarter wave plate 85 disposed between the optical path changer 83 and the signal beam modulator 81, and the optical path changer 83 may be a polarization beam splitter reflecting a beam with first linear polarization incident on the optical path changer 83 from the light source 100 and transmitting a beam with second linear polarization orthogonal to the first linear polarization. A quarter wave plate 103 may be further disposed between the first beam splitter 101 and the second beam splitter 105, and the second beam splitter 105 may be a PBS reflecting a beam with first linear polarization and transmitting a beam with second linear polarization orthogonal to the first linear polarization.

In this case, when the beam having first linear polarization to be reflected by the optical path changer 83 is an S-polarized beam, the first light beam LA with the first linear polarization is transmitted through the first beam splitter 101, reflected by the optical path changer 83, and changed into a beam with one circular polarization by the quarter wave plate 85. The beam LA with the one circular polarization is reflected by the signal beam modulator 81 and changed into a signal beam WB with other circular polarization for recording information. The signal beam WB for recording passes through the quarter wave plate 85 again to become a signal beam with second linear polarization, e.g., P-polarization, orthogonal to the first linear polarization, and is transmitted through the optical path changer 83 to the holographic medium 10. The second light beam LB with first linear polarization reflected by the first beam splitter 101 passes through the quarter wave plate 103 to become a beam with one circular polarization, and is split into the reference beam RB2 for recording with second linear polarization, and the reference beam RB1 for reproducing with first linear polarization by the second beam splitter 105.

Accordingly, during a recording mode, the signal beam WB for recording with the second linear polarization and the reference beam RB2 for recording with the second linear polarization are emitted to the holographic medium 10 to cross each other. During a reproduction mode, the reference beam RB1 for reproducing with the first linear polarization is emitted to the holographic medium 10, and the signal beam Lm with the first linear polarization diffracted by the holograms recorded on the holographic medium 10 is reflected by the optical path changer 83 and received by the signal beam sensor 70.

The present invention is not limited to the holographic information recording and/or reproducing apparatus employing the reference beam angle control signal generating system illustrated in FIG. 7, and various changes in the optical configuration and arrangement of the holographic information recording and/or reproducing apparatus may be made without departing from the scope and spirit of the present invention as defined by the attached claims.

While the holographic information recording and/or reproducing apparatus of FIG. 7 includes both the first reference beam emitting unit 20 and the second reference beam emitting unit 110, only the first reference beam emitting unit 20 may be employed to control the angle of a reference beam according to a reference beam angle control signal produced by the reference beam angle control signal generating system, and a reference beam emitted by the first reference beam emitting unit 20 may be used as both a reference beam for recording information and a reference beam for reproducing information.

Referring back to FIG. 1 and FIG. 2, basic components of a holographic information recording and/or reproducing apparatus further include a relay lens system 25 to relay the reference beam emitted from the first reference beam emitting unit 20 to the holographic medium 10; an aperture member 40 included in the lens system 30 to support first and second photo-detectors 51, 53 to detect signal beams Lₛ₁ and Lₛ₂ reproduced from the holographic medium 10; a signal beam sensor 70 and/or a signal beam provider 80 arranged to provide signal beams. According to example embodiments of the present invention, the lens system 30 and the signal processing unit 60 may be considered as a reference beam angle control signal generating system. The lens system 30 may be arranged to transmit the signal beams Lm, Lₛ₁, and Lₛ₂ reproduced from the specific book B2 and the first and second adjacent books B1 and B3. Specifically, the lens system 30 includes a first lens 31 arranged to convert the signal beam Lm reproduced from the holographic medium 10 into a parallel light beam; a second lens 33 arranged to focus the parallel light beam generated by the first lens 31 on a plane where the aperture 41 is disposed within the aperture member 40; and a third lens 35 which constitutes a relay lens system together with the second lens 33, and is adapted to convert the signal beam Lm focused by the second lens 33, expanded, and passing through the aperture 41 to be reproduced from the specific book into a parallel light beam and transmit the parallel light beam to the signal beam sensor 70. Since the lens system 30 can focus the signal beam Lm reproduced from the holographic medium 10 on the plane where the aperture 41 of the aperture member 40 is formed, the signal beams Lₛ₁ an Lₛ₂ reproduced from the first and second adjacent books are condensed on the first and second photo-detectors 51 and 53, and only the signal beam Lm reproduced from a specific book on the holographic medium 10 passes through the aperture 41 and propagates toward the third lens 35.

As described above, since a reference beam angle control signal is generated using signal beams reproduced from adjacent books respectively disposed on both sides of a specific book which is to be reproduced, the present invention can simply control a reference beam to be emitted at an optimum angle without loss of a signal beam reproduced from the specific book, and can simplify the construction of a system for generating the reference beam angle control signal.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. Accordingly, it is intended, therefore, that the present invention not be limited to the various example embodiments disclosed, but that the present invention includes all embodiments falling within the scope of the appended claims.

What is claimed is:

1. A system for generating a reference beam angle control signal, comprising:
first and second photo-detectors arranged, when record of two-dimensionally (2D) modulated signal beam superposed in the same volume of a holographic medium is called a book, to detect signal beams reproduced from first and second adjacent books respectively disposed on both sides of a specific book that is to be reproduced from the holographic medium; and
a signal processing unit arranged to obtain a reference beam angle control signal for controlling the incident angle of a reference beam emitted to the holographic medium using a differential signal between output signals of the first and second photo-detectors.

2. The system of claim 1, further comprising an aperture member disposed in the optical path of a signal beam reproduced when the emitted reference beam is diffracted by the holographic medium, and having an aperture through which only a signal beam reproduced from the specific book can pass,
wherein the first and second photo-detectors are integrally formed with the aperture member to be disposed on both sides of the aperture, respectively.

3. The system of claim 1, further comprising:
an aperture member disposed in the optical path of a signal beam reproduced when the emitted reference beam is diffracted by the holographic medium, and having an aperture through which only a signal beam reproduced from the specific book can pass; and
first and second mirrors integrally formed with the aperture member to be disposed on both sides of the aperture respectively, and reflecting signal beams reproduced from the first and second adjacent books,
wherein the first photo-detector detects a signal beam reflected by the first mirror, and the second photo-detector detects a signal beam reflected by the second mirror.

4. The system of claim 1, wherein the first and second photo-detectors are disposed to directly detect signal beams reproduced from the first and second adjacent books.

5. The system of claim 1, further comprising first and second mirrors reflecting signal beams reproduced from the first and second adjacent books,
wherein the first photo-detector detects a signal beam reflected by the first mirror, and the second photo-detector detects a signal beam reflected by the second mirror.

6. The system of claim 1, wherein the specific book, the first adjacent book, and the second adjacent book are recorded at different angles on the holographic medium.

7. The system of claim 6, wherein, when a hologram is recorded by a signal beam modulated in a 2D manner in the form of page, and the book refers to a record of the plurality of pages superposed in the same volume of the holographic medium,
an angular spacing between adjacent pages within the same book corresponds to an integer multiple of null Bragg selectivity, and an angular spacing between adjacent books corresponds to a ratio of null Bragg selectivity to n where n is greater than 1.

8. A holographic information recording and/or reproducing apparatus comprising:
a first reference beam emitting unit to adjust an incident angle of a reference beam and emit an adjusted reference beam to a holographic medium;
a signal beam sensor arranged, when a record of 2D modulated signal beam superposed in the same volume of the holographic medium is called a book, to detect a signal beam reproduced from a specific book that is to be reproduced from the holographic medium using the reference beam emitted by the first reference beam emitting unit; and
a system for generating a reference beam angle control signal to control the incident angle of the reference beam emitted by the first reference beam emitting unit to the holographic medium, wherein the system for generating the reference beam angle control signal comprises:
first and second photo-detectors arranged to detect signal beams reproduced from first and second adjacent books disposed on both sides of a specific book, respectively; and
a signal processing unit arranged to obtain a reference beam angle control signal for controlling the incident angle of the reference beam emitted by the first reference beam emitting unit to the holographic medium using a differential signal between output signals of the first and second photo-detectors.

9. The holographic information recording and/or reproducing apparatus of claim 8, further comprising:
a light source to emit light;
a first beam splitter to split the light emitted by the light source into two beams; and
a signal beam provider to modulate a first beam of the two beams splitted by the first beam splitter into a signal beam having a 2D signal pattern and to emit the signal beam having the 2D signal pattern to the holographic pattern,
wherein a second beam of the two beams splitted by the first beam splitter is used as a reference beam.

10. The holographic information recording and/or reproducing apparatus of claim 9, further comprising:
a second beam splitter to split the second beam of the two beams split by the first beam splitter into first and second reference beams; and
a second reference beam emitting unit to adjust the incident angle of the first reference beam to use for recording and to emit the adjusted reference beam to the holographic medium,
wherein the second reference beam is used as the reference beam emitted to the holographic medium by the first reference beam emitting unit.

11. The holographic information recording and/or reproducing apparatus of claim 10, wherein the first reference beam emitting unit comprises a pivoting mirror to reflect a reference beam incident thereon, such that the pivoting mirror is driven according to the reference beam angle control signal to adjust the angle of the reference beam.

12. The holographic information recording and/or reproducing apparatus of claim 8, wherein the first reference beam emitting unit comprises a pivoting mirror to reflect a reference beam incident thereon, such that during a reproduction process, the pivoting mirror is driven according to the reference beam angle control signal to adjust the angle of the reference beam.

13. The holographic information recording and/or reproducing apparatus of claim 8, further comprising an aperture member disposed in the optical path of a signal beam reproduced when the reference beam emitted by the first reference beam emitting unit is diffracted by the holographic medium, and having an aperture through which only a signal beam reproduced from the specific book can pass.

14. The holographic information recording and/or reproducing apparatus of claim 13, wherein the first and second photo-detectors are integrally formed with the aperture member to be disposed on both sides of the aperture respectively.

15. The holographic information recording and/or reproducing apparatus of claim 13, further comprising first and second mirrors integrally formed with the aperture member to be disposed on both sides of the aperture respectively, for reflecting the signal beams reproduced from the first and second adjacent books,
wherein the first photo-detector detects a signal beam reflected by the first mirror, and the second photo-detector detects a signal beam reflected by the second mirror.

16. The holographic information recording and/or reproducing apparatus of claim 13, further comprising a lens system to transmit the signal beams reproduced from the specific book and the first and second adjacent books.

17. The holographic information recording and/or reproducing apparatus of claim 16, wherein the lens system comprises:
a first lens arranged to convert the signal beam reproduced from the holographic medium into a parallel beam; and
a second lens arranged to focus the parallel beam output from the first lens on a plane including the aperture.

18. The holographic information recording and/or reproducing apparatus of claim 17, wherein the lens system further comprises a third lens arranged to convert the signal beam focused by the second lens, and then diversed, and to pass through the aperture to be reproduced from the specific book into a parallel beam and to transmit the parallel beam to the signal beam sensor.

19. The holographic information recording and/or reproducing apparatus of claim 8, wherein the first and second photo-detectors are disposed to directly detect the signal beams reproduced from the first and second adjacent books.

20. The holographic information recording and/or reproducing apparatus of claim 8, further comprising first and second mirrors arranged to reflect the signal beams reproduced from the first and second adjacent books,
wherein the first photo-detector detects a signal beam reflected by the first mirror, and the second photo-detector detects a signal beam reflected by the second mirror.

21. The holographic information recording and/or reproducing apparatus of claim 8, wherein the signal beam emitted by the signal beam provider to the holographic medium and the signal beam reproduced from the specific book on the holographic medium travel in the same path.

22. The holographic information recording and/or reproducing apparatus of claim 8, wherein the specific book, the first adjacent book, and the second adjacent book are recorded at different angles on the holographic medium.

23. The holographic information recording and/or reproducing apparatus of claim 22, wherein, when a hologram is recorded by a signal beam modulated in a 2D manner in the form of page, and the book refers to a record of the plurality of pages superposed in the same volume of the holographic medium,
an angular spacing between adjacent pages within the same book corresponds to an integer multiple of null Bragg selectivity, and an angular spacing between adjacent books corresponds to a ratio of null Bragg selectivity to n where n is greater than 1.

24. A holographic information recording and/or reproducing apparatus for recording and/or reproducing information on/from a holographic medium in which a hologram is recorded in the form of a page and a record of a plurality of pages superposed in the same volume of the holographic medium is referred to as a book, the apparatus comprising:
a reference beam emitter to emit a reference beam to the holographic medium;
a signal beam sensor arranged to detect a signal beam reproduced from a specific book that is to be reproduced from the holographic medium using the reference beam emitted by the reference beam emitter;
an aperture member disposed in an optical path of the signal beam reproduced when the reference beam is diffracted by the holographic medium, and having an aperture through which only the signal beam reproduced from the specific book can pass, first and second photo-detectors disposed on both sides of the aperture to detect signal beams reproduced from first and second adjacent books disposed on both sides of a specific book, respectively; and
a signal processor to generate a reference beam angle control signal for controlling an incident angle of the reference beam emitted by the reference beam emitter to the holographic medium using a differential signal between output signals of the first and second photo-detectors.

25. The holographic information recording and/or reproducing apparatus of claim 24, further comprising:
a light source to emit light;
a first beam splitter to split the light emitted by the light source into two beams; and
a signal beam provider to modulate a first beam of the two beams splitted by the first beam splitter into a signal beam having a 2D signal pattern and to emit the signal beam having the 2D signal pattern to the holographic pattern,
wherein a second beam of the two beams splitted by the first beam splitter is used as a reference beam.

26. The holographic information recording and/or reproducing apparatus of claim 25, further comprising:
a second beam splitter to split the second beam of the two beams split by the first beam splitter into first and second reference beams; and
a second reference beam emitter to adjust the incident angle of the first reference beam to use for recording and to emit an adjusted reference beam to the holographic medium,
wherein the second reference beam is used as the reference beam emitted to the holographic medium by the reference beam emitter.

27. The holographic information recording and/or reproducing apparatus of claim 24, wherein the reference beam emitter comprises a pivoting mirror to reflect a reference beam incident thereon, such that during a reproduction process, the pivoting mirror is driven according to the reference beam angle control signal to adjust the angle of the reference beam.

28. The holographic information recording and/or reproducing apparatus of claim 24, further comprising first and second mirrors integrally formed with the aperture member to be disposed on both sides of the aperture respectively, for reflecting the signal beams reproduced from the first and second adjacent books,
wherein the first photo-detector detects a signal beam reflected by the first mirror, and the second photo-detector detects a signal beam reflected by the second mirror.

29. The holographic information recording and/or reproducing apparatus of claim 24, further comprising:
a first lens arranged to convert the signal beam reproduced from the holographic medium into a parallel beam;
a second lens arranged to focus the parallel beam output from the first lens on a plane including the aperture; and
a third lens arranged to convert the signal beam focused by the second lens, and then diversed, pass through the aperture to be reproduced from the specific book into a parallel beam and transmit the parallel beam to the signal beam sensor.

30. The holographic information recording and/or reproducing apparatus of claim 24, wherein the specific book, the first adjacent book, and the second adjacent book are recorded at different angles on the holographic medium, an angular spacing between adjacent pages within the same book corresponds to an integer multiple of null Bragg selectivity, and an angular spacing between adjacent books corresponds to a ratio of null Bragg selectivity to n where n is greater than 1.
